(19) United States
(12) Patent Application Publication
(10) Pub. No.: US 2012/0118998 A1
(43) Pub. Date: May 17, 2012

(54) Adjustable flow jet irrigator device

(76) Inventor: Arno Drechsel, Lienz (AT)

(21) Appl. No.: 13/294,834

(22) Filed: Nov. 11, 2011

(30) Foreign Application Priority Data
Nov. 12, 2010 (IT) VI2010A000302

(51) Int. Cl. B05B 1/30

(52) U.S. Cl. 239/533.1

(57) ABSTRACT

An adjustable flow jet irrigator includes a tubular conduit (3, 13) for the passage of an irrigation liquid flow having a predetermined pressure (P), the conduit (3, 13) having an inlet (5, 15) adapted to be connected to a liquid feeding line and an outlet (6 16) with a peripheral edge (7, 17), a liquid supply nozzle (8, 18), having an annular wall (21) with an inlet opening (22) fluidically connected to the outlet (6, 16) of the tubular conduit (3, 13) and an outlet opening (23) for feeding the flow at a predetermined flow rate (Q). The annular wall (21) of the nozzle (8, 18) has at least one elastically yielding portion (24) adapted to automatically and progressively deform in response to an increasing pressure (P) of the flow in the conduit (3, 13).

### FIELD OF THE INVENTION

The present invention generally finds application in the field of irrigation systems for agricultural areas, and particularly relates to an adjustable flow jet irrigator.

### BACKGROUND ART

Irrigator devices for agricultural areas are known to generally comprise a tubular conduit which is designed to be connected to an irrigation liquid feeding line, and has an end nozzle with an outlet opening having a constant predetermined diameter.

The nozzle is designed to direct a liquid jet to the soil to be irrigated, directly or through flow diverters.

The fluid flow rate and range values depend both on liquid feeding pressure and on the outlet diameter of the nozzle.

A first type of irrigation devices includes the so-called irrigation guns, which consist of a jet pipe with a nozzle at one end for directing a fluid jet over a predetermined range, to irrigate even soil portions remote from the device.

Irrigators are also known, which consist of a tubular conduit mounted to a support arm in a substantially vertical position and having the supply nozzle at one end.

Here, the fluid jet emitted by the nozzle is directed towards a deflector plate, which is arranged to pivot about a substantially vertical axis, to distribute the irrigation liquid over the soil portion below the device.

A first type of irrigation system with which the irrigator device can be associated is the so-called center pivot irrigator, which is designed for irrigation of large surfaces.

This system has a bearing arm, which is hinged at one end to pivot about a central point and irrigate a circular surface of a generally quadrangular land.

A plurality of irrigator devices are mounted to the arm, for directing the jet to the area underlying the device.

An additional jet irrigator device of the gun-type may be also mounted to the non-hinged end of the arm, to define an extension of such arm and irrigate the angular sectors of the land that are not covered by the arm.

In a particular variant, the central arm of the system may have an articulated extension, known as corner arm, which is hinged to the free end of the arm and is equipped with a plurality of jet irrigator devices of the sprinkler type to irrigate part of the angular sectors of the land.

In this case, if a gun device is provided, it can be pivotally mounted to the free end of the corner arm to further increase the irrigable surface.

A further irrigation device that uses gun devices is the so-called waterreel, which has a hose of predetermined diameter and length wound around a turning reel, and a cart at one end with the device mounted thereto.

In operation, the device swings through a predetermined angle about a vertical axis, while the hose is rolled on the reel at a predetermined speed, to deliver a predetermined water amount to the irrigation surface. In this case, the land to be irrigated always has a rectangular shape.

In any case, in order to ensure uniform and efficient water delivery and reduce waste, both the flow rate and range from the nozzle shall be suitably adjusted.

Such adjustment is particularly important in systems that are designed to irrigate lands extending remote from the irrigation system or if the land to be irrigated is divided into multiple areas with different crops, requiring different water delivery amounts.

Combined flow range and rate adjustment allows irrigation of remote land areas, while ensuring substantially uniform liquid distribution per unit area.

In prior art devices, such adjustment is essentially obtained by changing liquid pressure in the conduit.

Particularly, any increase or reduction of liquid pressure will be reflected in an increase or reduction of the range or flow rate of the delivered liquid.

Typically, pressure is adjusted from the irrigation liquid feeding means upstream from the conduit.

Flow rate and/or range changes may be also obtained by replacing the nozzle with another nozzle having a different outlet diameter.

Here, assuming an equal pressure and given pressure limits, the use of a nozzle with a larger outlet diameter will provide larger flow rate and range.

Therefore, the use of a set of nozzles with different outlet diameters allows flow rate and range adjustment within relatively wide ranges of values.

Nevertheless, these solutions appear to be poorly flexible in use, and to prevent dynamic adjustment of the characteristics of the delivered flow according to the requirements of the particular portion of the land to be irrigated.

Particularly, systems with gun devices do not ensure optimal irrigation of land portions as their distance from the irrigator device changes within a predetermined range of distances.

A further drawback of these solutions is that the flow of irrigation liquid from fixed-nozzle irrigation nozzles may be strongly affected by pressure bursts in the feeding line, which may cause considerable changes in temporary jet distribution.

Furthermore, the use of nozzles having different diameters involves the apparent problem of requiring replacement thereof, which is a difficult and time-consuming operation.

Also, the need for a relatively large number of nozzles to ensure a maximized range of flow rates and ranges is an apparent economic drawback.

### DISCLOSURE OF THE INVENTION

The object of the present invention is to overcome the above drawbacks, by providing an adjustable flow jet irrigator that is highly efficient and relatively cost-effective.

A particular object is to provide an irrigator device that provides an irrigation liquid flow having automatically adjustable flow rate and range in a wide operating range using a single nozzle.

A particular object is to provide an irrigator device that requires no system shutdown to seamlessly deliver an adjustable liquid flow from the minimum range to the maximum range, while maintaining a substantially uniform distribution of liquid to the soil.

A particular object is to provide an irrigator device that ensures high accuracy in setting the liquid flow rate and range, and affords easy and simple installation, to provide a reliable and constant behavior with time.

These and other objects, as better explained below, are fulfilled by an adjustable flow jet irrigator as defined in claim 1, which comprises a tubular conduit for the passage of an irrigation liquid flow having a predetermined pressure, said conduit having an inlet adapted to be connected to a liquid feeding line and an outlet with a peripheral edge, a liquid supply nozzle having an annular wall with an inlet opening fluidically connected to said outlet of the tubular conduit and an outlet opening for feeding the flow at a predetermined flow rate.

The device is characterized in that the annular wall of said nozzle has at least one elastically yielding portion which is adapted to automatically and progressively deform in response to an increasing pressure of the flow in the conduit.

With this particular configuration, the flow rate and range may be automatically adjusted using a single supply nozzle.

Particularly, as the liquid feeding pressure increases, the outlet diameter of the nozzle will also increase, and both the flow rate and range will accordingly increase.

Therefore, a single nozzle will be able to cover a continuous range of flow rate and range values that would require a larger number of discrete rigid nozzles.

Advantageous embodiments of the invention are defined in accordance with the dependent claims.

### BRIEF DESCRIPTION OF THE DRAWINGS

Further characteristics and advantages of the invention will become more apparent upon reading of the detailed description of a few preferred, non exclusive embodiments of an irrigator device of the invention, which are described as non limiting examples with the help with the accompanying drawings in which:

FIG. 1 is a partially broken-away perspective view of an irrigator device of the invention in a first preferred configuration;

FIG. 2 is a partially broken-away view of an irrigator device of the invention in a second preferred configuration;

FIG. 3 is a broken-away perspective view of a detail of the device of FIG. 1, having a supply nozzle according to a first preferred embodiment and in undeformed state;

FIG. 4 is a sectional front view of the detail of FIG. 3;

FIG. 5 is a broken-away perspective view of a detail of the device of FIG. 1, having a supply nozzle according to a second preferred embodiment and in undeformed state;

FIG. 6 is a sectional front view of the detail of FIG. 5;

FIG. 7 is a broken-away perspective view of a supply nozzle according to a third embodiment and in three different deformed operating states;

FIG. 8 is a broken-away perspective view of the detail of FIG. 3, with the supply nozzle in three different deformed operating states;

FIG. 9 shows a comparative diagram of flow rate W as a function of pressure P for an inventive device and for three prior art devices.

### DETAILED DESCRIPTION OF A PREFERRED EMBODIMENT

Referring to the above figures, the irrigator device of the invention, generally designated by numeral 1, may be used in an irrigation system, not shown, at one outlet thereof.

The device 1 may be installed both in fixed and movable irrigation systems, such as “center pivot” irrigation systems, with or without “corner arms”, and in systems known as “waterreels”, without requiring particular changes for adaptation to the characteristics of each particular system.

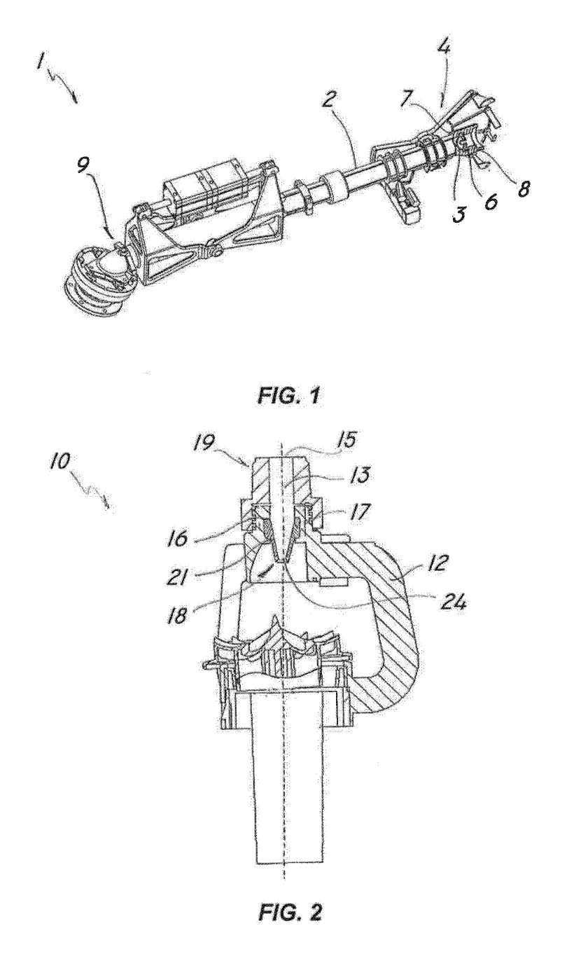

Particularly, FIG. 1 shows an irrigator device 1 having a jet pipe 2 with an inner tubular conduit 3 for the passage of an irrigation liquid flow having a predetermined pressure P, to define a long-range gun 4.

The conduit 3 has an inlet 5, which is adapted to be connected to a liquid feeding line of the system and an outlet 6 with a peripheral edge 7, having a liquid supply nozzle 8 attached thereto.

This device 1 is particularly suitable for use in movable irrigation systems, particularly of center pivot type.

Here, the device 1 may be fixed to one end of the pivoting arm of the system, to irrigate the angular sectors of a rectangular land.

The inner circular area of the land will be covered by the pivoting arm, and will be irrigated, as is known to the skilled person, by a plurality of irrigator devices which are adapted to pivot with the arm.

The device 1 may be hinged at one end 9 of the jet pipe 2 to pivot about it and allow irrigation of the angular sector of the land, particularly when it is designed for a center pivot system having a corner arm or for a waterreel system.

Nevertheless, the device 1 may be also mounted in a non-rigid manner at the first end 9, e.g. if it is directly mounted to the central arm of a center pivot system.

FIG. 2 shows a second preferred, non-limiting embodiment of the device, generally referenced 10.

Here, the device 10 is a rotary sprinkler, having a load bearing frame 12 with the tubular conduit 13 for the passage of fluid, which is designed to be fastened to a fixed or movable part of the irrigation system.

Here again, the conduit 13 has an inlet 15 that is adapted to be connected to a liquid feeding line and an outlet 16 associated with a flow supply nozzle 18.

The nozzle 18 is attached to the lateral edge 17 of the outlet 16.

The load-bearing frame 12 is adapted to be anchored to the support arm of the irrigation system, and is stationary relative thereto, at a first end 19 proximate to the inlet 15 of the conduit 13.

The nozzle 18 faces towards a deflector plate 20 which is adapted to deflect and sprinkle the flow over the portion of soil below the device 10.

This particular type of irrigator device 10 may be used in both fixed and movable systems and is particularly suitable for the above mentioned center pivot systems.

Here, the device 10 is designed to be fastened to the pivoting arm or the corner arm, if any, along the extension thereof, to be pivotally moved about the center axis of the system, as is well known to the skilled person.

The device 1 of FIG. 1 will be only described in greater detail below, although it shall be intended that the description of such device 1, particularly concerning the nozzle 8, will also apply to the device 10 of FIG. 2 and in its nozzle 18.

Also, the above described configurations of the device 1, 10 shall be merely intended by way of example and without limitation to the present invention.

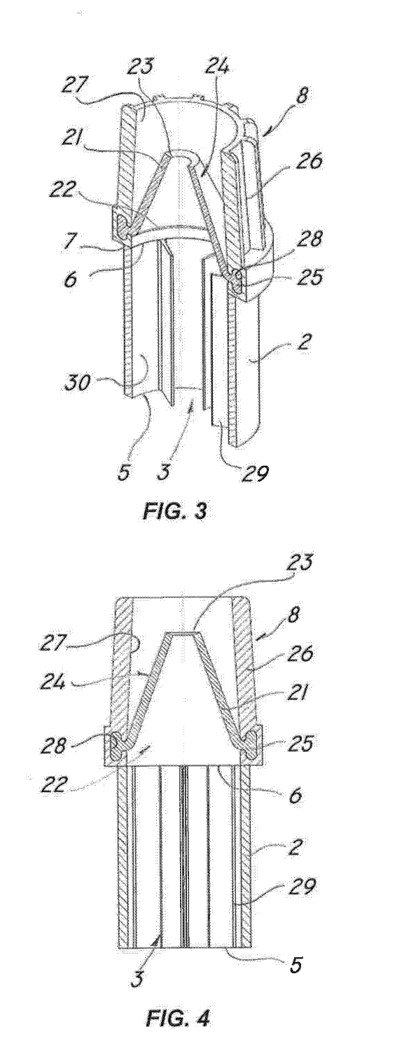

As more clearly shown in FIG. 3, the supply nozzle 8 has an annular wall 21 with an inlet opening 22 fluidically connected to the outlet 6, 16 of the tubular conduit 3 and an outlet opening 23 for feeding the flow at a predetermined flow rate Q.

According to a peculiar feature of the invention, the annular wall 21 of the nozzle 8 has at least one elastically yielding portion 24 which is adapted to automatically and progressively deform in response to an increasing pressure P of the flow in the conduit 3.

Furthermore, the nozzle 8 has a peripheral portion 25 with a substantially constant outer diameter dₑ, which is adapted to be operatively coupled to the outlet 6 of the tubular conduit 3.

The outlet opening 23 has an inner diameter dᵢ preferably smaller than the outer diameter dₑ of the peripheral portion 25.

Preferably, the elastically yielding portion 24 is close to the outlet opening 23 and particularly the latter is formed in a central part of the elastically yielding portion 24.

Thus, the inner diameter dᵢ of the outlet opening 23 can vary from a minimum value d_{iMIN} to a maximum value d_{iMAX}.

Particularly, the minimum diameter d_{iMIN} represents the value of the inner diameter dᵢ of the outlet opening 23 at the minimum or zero value of fluid pressure P, which corresponds to the undeformed state of the annular wall 21.

The maximum diameter d_{iMAX} represents the value of the inner diameter dᵢ at the maximum value of fluid pressure P, with the annular wall 21 in a wholly deformed condition.

Preferably, the annular wall 21 is wholly deformable, with the yielding portion 24 and the peripheral portion 25 integrally joined and formed of the same elastomeric material, having a predetermined stiffness constant.

The material of the deformable portion 24, or the whole annular wall 21 may be any elastomeric material.

Preferably, the elastomeric material shall have an adequate elasticity and a high elongation.

Furthermore, the elastomeric material shall exhibit a small elastic hysteresis to ensure identical operation both with increasing pressure P and with decreasing pressure.

The material may have any hardness whatever, as long as it ensures sufficient elasticity, and preferably a hardness ranging from 20 ShA to 60 ShA and more preferably from 30 ShA to 50 ShA.

Preferably, the elastomeric material is selected from the group comprising natural rubbers, such as caoutchouc, silicone rubbers, butyl compounds, nitrile rubbers and the like.

In the illustrated configurations, the deformable portion 24, in its undeformed state, has a substantially constant thickness s.

Nevertheless, the annular wall 21 may be also formed with a variable thickness s, to provide various operation profiles.

The annular wall 21 of the nozzle 8 may be modeled in various configurations, depending on the flow rate W and range g profiles to be achieved with changing pressure P, with no particular shape or size limitation.

Therefore, the configurations of the figures shall be intended as merely illustrative and without limitation.

Particularly, FIGS. 3 and 4 show a nozzle 8 having a substantially frustoconical annular wall 21, converging towards the outlet opening 23.

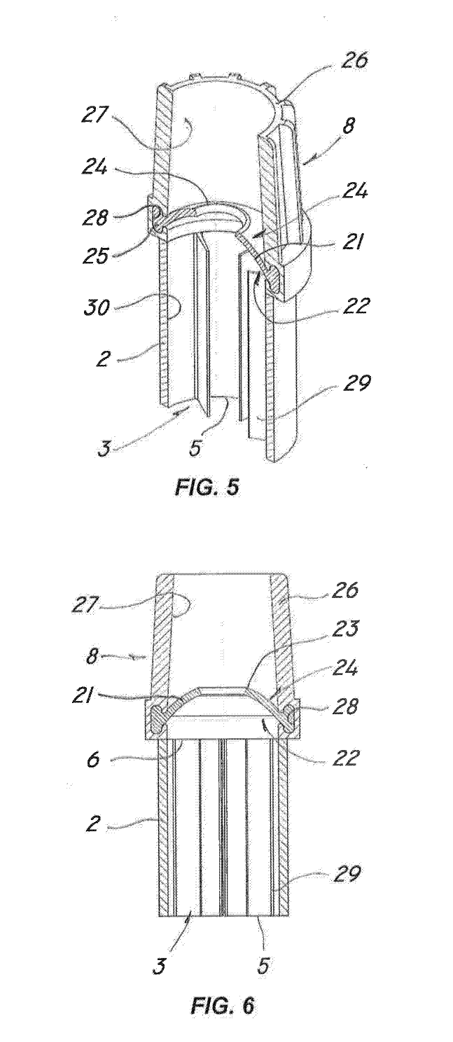

FIGS. 5 and 6 show a nozzle 8 having a substantially dome-shaped annular wall 21, whose concavity faces towards the outlet 6 of the conduit 3.

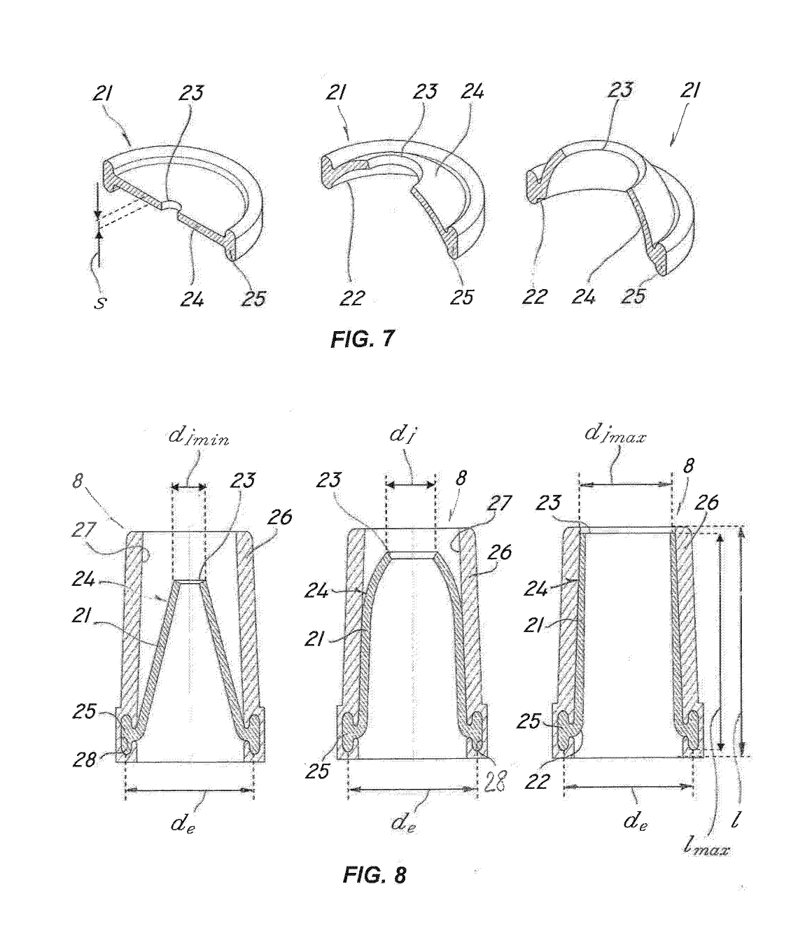

Finally, FIG. 7 shows a nozzle 8 having a substantially disk-shaped annular wall 21 in a deformation sequence reflecting, an increase of the flow pressure P in the conduit 3, from left to right.

The nozzle 8 also comprises a substantially tubular anchor element 26 which is coupled to the peripheral portion 25 of the annular wall 21 and is adapted to be fastened to the peripheral edge 7 of the tubular conduit 3.

Advantageously, the anchor element 26 has a substantially tubular shape and is coaxial both with the tubular conduit 3 and with the annular wall 21.

Furthermore, its length l will be greater than the maximum length l_{MAX} of the annular wall 21 in the most deformed state.

Thus, the inner lateral surface of the anchor element 26 defines an abutment for the deformable portion 24 of the annular wall 21 during its deformation, as more clearly shown in FIG. 8.

This figure shows a nozzle 8 having a frustoconical annular wall 21 in a deformation sequence reflecting, an increase of the flow pressure P in the conduit, from left to right.

The anchor element 26 may have a peripheral groove 28 for stably accommodating the peripheral portion 25 of the annular wall 21, e.g. by press-fit of the peripheral portion 25 therein.

The anchor element 26 may be coupled to the peripheral edge 6 of the tubular conduit 3 by mutually screwing them together, or by fitting the latter into a specially provided seat of the former, not shown.

Furthermore, the tubular conduit 3 may have a plurality of substantially axial tabs 29, which radially project out of the inner peripheral surface 30.

The tabs 29 have the purpose of stabilizing the flow, by promoting parallel arrangement of fluid flows.

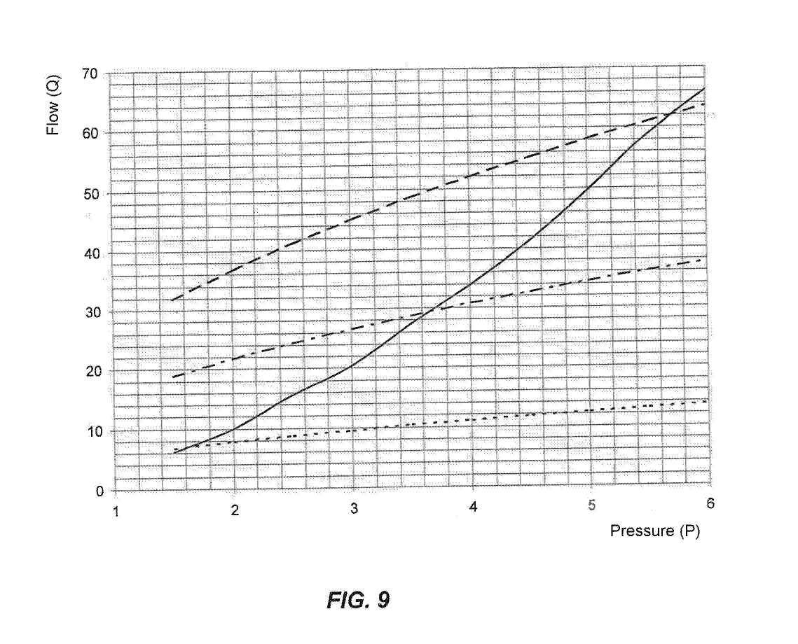

FIG. 9 shows a diagram of the flow rate Q as a function of the feeding pressure P for a device 1, 10 of the invention, as compared with the respective P/Q diagrams for three prior art devices.

Particularly, the solid line designates a pressure/flow rate (P/Q) curve for the prior art device 1 having a nozzle 8 with a deformable portion 24 made of a commercially available compound, sold by APPLIED RUBBER LININGS LIMITED under the code ARL/50 WQB, which has a hardness of about 50 ShA, 11 MPa tensile strength and 630% elongation at break.

The broken lines designate the corresponding P/Q curves for prior art devices having rigid nozzles with outlet openings having different inner diameters 1, 2, 3, increasing from the bottom curve to the top curve.

These curves reflect the following table, which shows both the inner diameter dᵢ and flow rate Q values with changing pressure P, for the device 1 of the invention.

For rigid nozzles, the flow rate values Q the table shows the flow rate Q values with changing pressure P.

TABLE

| Pres- | | | | | | | | |
|---|---|---|---|---|---|---|---|---|
| sure | | | | | | | | |
| P | dᵢ | Ø₁ | Ø₂ | Ø₃ | Q(dᵢ) | Q(Ø₁) | Q(Ø₂) | Q(Ø₃) |
| [bar] | [mm] | [mm] | [mm] | [mm] | [m³/h] | [m³/h] | [m³/h] | [m³/h] |
| 1.5 | 11.5 | 12 | 20 | 26 | 6.22 | 6.77 | 18.81 | 31.79 |
| 2.0 | 13.5 | 12 | 20 | 26 | 9.90 | 7.82 | 21.72 | 36.71 |
| 2.5 | 16 | 12 | 20 | 26 | 15.54 | 8.74 | 24.28 | 41.04 |
| 3.0 | 17.5 | 12 | 20 | 26 | 20.37 | 9.58 | 26.60 | 44.96 |
| 3.5 | 19.5 | 12 | 20 | 26 | 27.31 | 10.34 | 28.73 | 48.56 |
| 4.0 | 21 | 12 | 20 | 26 | 33.87 | 11.06 | 30.72 | 51.91 |
| 4.5 | 22.5 | 12 | 20 | 26 | 41.23 | 11.73 | 32.58 | 55.06 |
| 5.0 | 24 | 12 | 20 | 26 | 49.45 | 12.36 | 34.34 | 58.04 |
| 5.5 | 25.5 | 12 | 20 | 26 | 58.55 | 12.97 | 36.02 | 60.87 |
| 6.0 | 26.5 | 12 | 20 | 26 | 66.05 | 13.54 | 37.62 | 63.58 |

As shown above, an irrigation system having a stationary supply nozzle and a feeding pressure P changing within a given range may generate a flow having a maximum flow rate Q and a range g increased by twice the value obtained with the minimum operating pressure.

The table clearly shows that, using a single nozzle 8, the device 1 of the invention can provide a flow rate Q(dᵢ) falling in a range that includes all the flow rate values Q(φ₁), Q(φ₂), Q(φ₃) that might be obtained, with the same change of pressure P, using three different nozzles having different inner diameters φ₁, φ₂, φ₃.

Furthermore, the flow rate value Q at the maximum pressure P might be even ten times higher than the value corresponding to the minimum pressure P.

This will provide an increase of the flow range g, proportional to the increase of the flow rate Q.

The above disclosure clearly shows that the invention fulfills the intended objects, and particularly meets the requirement of providing an adjustable flow irrigator device for irrigation systems that allows irrigation flow rate and range adjustment within wide ranges, using a single supply nozzle.

The device of the invention is susceptible to a number of changes and variants, within the inventive concept disclosed in the appended claims. All the details thereof may be replaced by other technically equivalent parts, and the materials may vary depending on different needs, without departure from the scope of the invention.

While the device has been described with particular reference to the accompanying figures, the numerals referred to in the disclosure and claims are only used for the sake of a better intelligibility of the invention and shall not be intended to limit the claimed scope in any manner.

The invention claimed is:

1. An adjustable flow jet irrigator device comprising:
a tubular conduit (3, 13) for passage of an irrigation liquid flow having predetermined pressure (P), said conduit (3, 13) having an inlet (5, 15) connectable to a feeding line of the liquid and an outlet (6, 16) with a peripheral edge (7, 17); and
a nozzle (8, 18) for supplying the liquid, said nozzle (8, 18) having an annular wall (21) with an inlet opening (22) fluidically connected to said outlet (6, 16) of said tubular conduit (3, 13) and an outlet opening (23) for feeding the flow with a predetermined flow rate (Q),
wherein said annular wall (21) of said nozzle (8, 18) has at least one elastically yielding portion (24) adapted to automatically and progressively deform itself in response to increasing pressure (P) of the flow into said conduit (3, 13).

2. The irrigation device as claimed in claim 1, wherein said at least one elastically yielding portion (24) is close to said outlet opening (23).

3. The irrigation device as claimed in claim 1, wherein said nozzle (8, 18) has a peripheral portion (25) with a substantially constant outer diameter (dₑ), said peripheral portion (25) being adapted to be operatively coupled to the outlet (6, 16) of said tubular conduit (3, 13).

4. The irrigation device as claimed in claim 3, wherein said yielding portion (24) and said peripheral portion (25) of said annular wall (21) are unitary and made in an elastomeric material selected among the group consisting of natural, siliconic, butylic, and nitrilic rubber.

5. The irrigation device as claimed in claim 3, wherein said nozzle (8, 18) comprises a substantially tubular anchoring element (26) that is coupled with said peripheral portion (25) of said annular wall (21) and adapted to be fastened to said peripheral edge (7, 17) of said tubular conduit (3, 13).

6. The irrigation device as claimed in claim 5, wherein said anchoring element (26) has a length (l) greater than a maximum length (l_{MAX}) of said annular wall (21) in a completely deformed condition.

7. The irrigation device as claimed in claim 1, wherein said outlet opening (23) is formed in a central part of said elastically yielding portion (24) and has an inner diameter (dᵢ) which can vary between a minimum value (d_{iMIN}) and a maximum value (d_{iMAX}).

8. The irrigation device as claimed in claim 7, wherein said minimum value of the inner diameter (d_{iMIN}) corresponds to the inner diameter (dᵢ) of said outlet opening (23) in correspondence of the minimum value of the fluid pressure (P) and with said yielding portion (24) in a substantially undeformed condition.

9. The irrigation device as claimed in claim 7, wherein said maximum value of the inner diameter (d_{iMAX}) corresponds to the inner diameter (dᵢ) of said outlet opening (23) in correspondence of the maximum value of the fluid pressure (P) and with said yielding portion (24) in a completely deformed condition.

10. The irrigation device as claimed in claim 9, wherein said yielding portion (24) of said annular wall (21), in said undeformed condition, is substantially disk-like shaped, substantially frustoconical, or spherical cap shaped.
